(19) United States
(12) Patent Application Publication
(10) Pub. No.: US 2025/0211306 A1
(43) Pub. Date: Jun. 26, 2025

(54) CHANNEL STATE INFORMATION REPORTING FOR MULTIPLE CHANNEL MEASUREMENT RESOURCE GROUPS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US); Tao LUO, San Diego, CA (US)

(21) Appl. No.: 18/849,161

(22) PCT Filed: May 27, 2022
(86) PCT No.: PCT/CN2022/095616

§ 371 Date: Sep. 20, 2024

(51) Int. Cl. H04B 7/06; H04B 17/318; H04W 24/10

(52) U.S. Cl. CPC H04B 7/0626; H04B 17/328; H04W 24/10

(57) ABSTRACT

Various aspects of the present disclosure generally relate to wireless communication. In some aspects, a user equipment (UE) may transmit, to a network node, a first channel state information (CSI) report, wherein the first CSI report indicates layer 1 (L1) reference signal received power (RSRP) or signal-to-interference-plus-noise ratio (SINR) (L1-RSRP/SINR) measurements and associated channel measurement resource (CMR) identifiers (IDs) based at least in part on multiple CMR sets that are grouped together. The UE may transmit, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report. Numerous other aspects are described.

### FIELD OF THE DISCLOSURE

Aspects of the present disclosure generally relate to wireless communication and to techniques and apparatuses for channel state information reporting for multiple channel measurement resource groups.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: transmit, to a network node, a first channel state information (CSI) report, wherein the first CSI report indicates layer 1 (L1) reference signal received power (RSRP) or signal-to-interference-plus-noise ratio (SINR) (L1-RSRP/SINR) measurements and associated channel measurement resource (CMR) identifiers (IDs) based at least in part on multiple CMR sets that are grouped together; and transmit, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

In some implementations, an apparatus for wireless communication at a network node includes a memory and one or more processors, coupled to the memory, configured to: receive, from a UE, a first CSI report, wherein the first CSI report indicates L1-RSRP/SINR measurements and associated CMR IDs based at least in part on multiple CMR sets that are grouped together; and receive, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

In some implementations, a method of wireless communication performed by a UE includes transmitting, to a network node, a first CSI report, wherein the first CSI report indicates L1-RSRP/SINR measurements and associated CMR IDs based at least in part on multiple CMR sets that are grouped together; and transmitting, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

In some implementations, a method of wireless communication performed by a network node includes receiving, from a UE, a first CSI report, wherein the first CSI report indicates L1-RSRP/SINR measurements and associated CMR IDs based at least in part on multiple CMR sets that are grouped together; and receiving, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

In some implementations, a non-transitory computer-readable medium storing a set of instructions for wireless communication includes one or more instructions that, when executed by one or more processors of a UE, cause the UE to: transmit, to a network node, a first CSI report, wherein the first CSI report indicates L1-RSRP/SINR measurements and associated CMR IDs based at least in part on multiple CMR sets that are grouped together; and transmit, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

In some implementations, a non-transitory computer-readable medium storing a set of instructions for wireless communication includes one or more instructions that, when executed by one or more processors of a network node, cause the network node to: receive, from a UE, a first CSI report, wherein the first CSI report indicates L1-RSRP/SINR measurements and associated CMR IDs based at least in part on multiple CMR sets that are grouped together; and receive, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

In some implementations, an apparatus for wireless communication includes means for transmitting, to a network node, a first CSI report, wherein the first CSI report indicates L1-RSRP/SINR measurements and associated CMR IDs based at least in part on multiple CMR sets that are grouped together; and means for transmitting, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

In some implementations, an apparatus for wireless communication includes means for receiving, from a UE, a first CSI report, wherein the first CSI report indicates L1-RSRP/SINR measurements and associated CMR IDs based at least in part on multiple CMR sets that are grouped together; and means for receiving, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example of beam management, in accordance with the present disclosure.

FIG. 6 is a diagram illustrating an example of wireless communications, in accordance with the present disclosure.

FIG. 7 is a diagram illustrating an example of an artificial intelligence/machine learning (AI/ML)-based time domain beam prediction, in accordance with the present disclosure.

FIG. 8 is a diagram illustrating an example of layer 1 (L1) reporting for multiple transmission reception points (TRPs), in accordance with the present disclosure.

FIG. 9 is a diagram illustrating an example of time domain beam prediction, in accordance with the present disclosure.

FIG. 10 is a diagram illustrating an example associated with channel state information (CSI) reporting for multiple channel measurement resource (CMR) groups, in accordance with the present disclosure.

FIGS. 11-12 are diagrams illustrating example processes associated with CSI reporting for multiple CMR groups, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

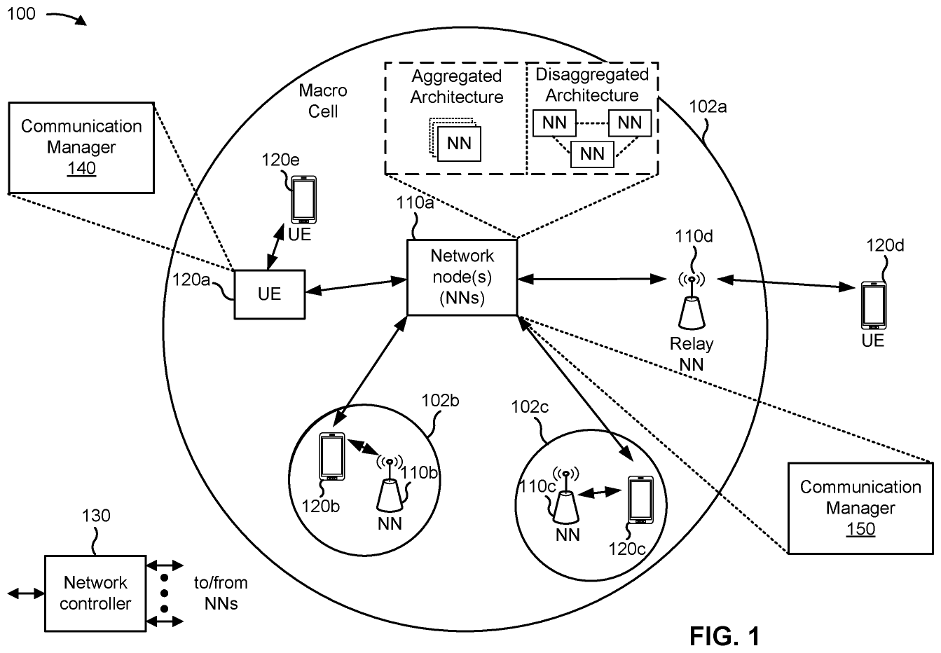

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4,FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may transmit, to a network node, a first channel state information (CSI) report, wherein the first CSI report indicates layer 1 (L1) reference signal received power (RSRP) or signal-to-interference-plus-noise ratio (SINR) (L1-RSRP/SINR) measurements and associated channel measurement resource (CMR) identifiers (IDs) based at least in part on multiple CMR sets that are grouped together; and transmit, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report. Additionally, or alternatively, the communication manager 140 may perform one or more other operations described herein.

In some aspects, a network node (e.g., network node 110) may include a communication manager 150. As described in more detail elsewhere herein, the communication manager 150 may receive, from a UE, a first CSI report, wherein the first CSI report indicates L1-RSRP/SINR measurements and associated CMR IDs based at least in part on multiple CMR sets that are grouped together; and receive, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report. Additionally, or alternatively, the communication manager 150 may perform one or more other operations described herein.

As indicated above, FIG. 1 is provided as an example. Other examples may differ from what is described with regard to FIG. 1.

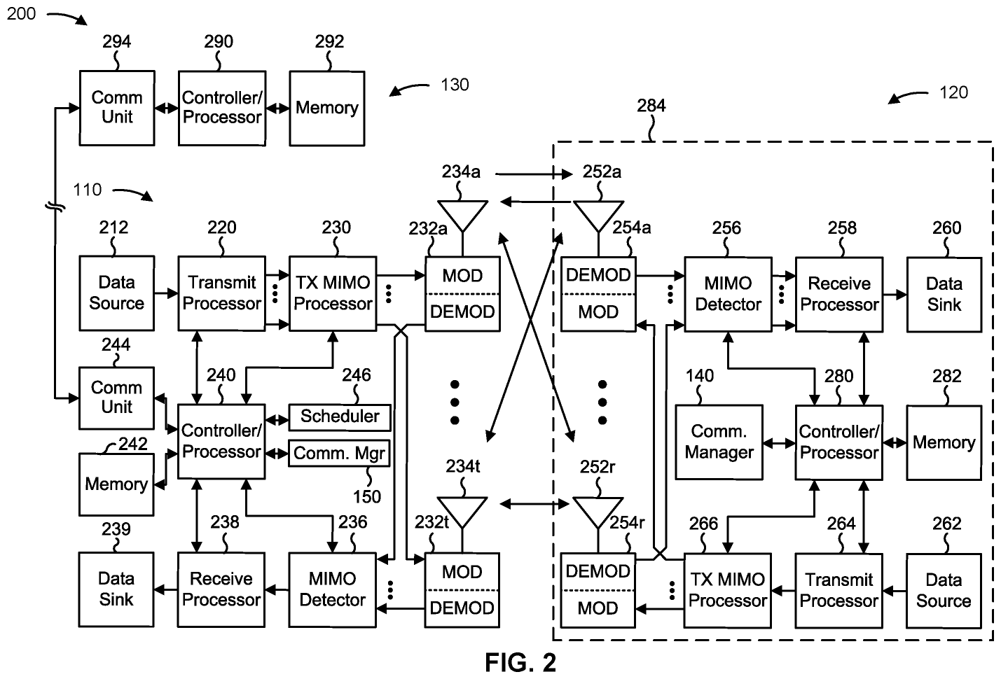

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

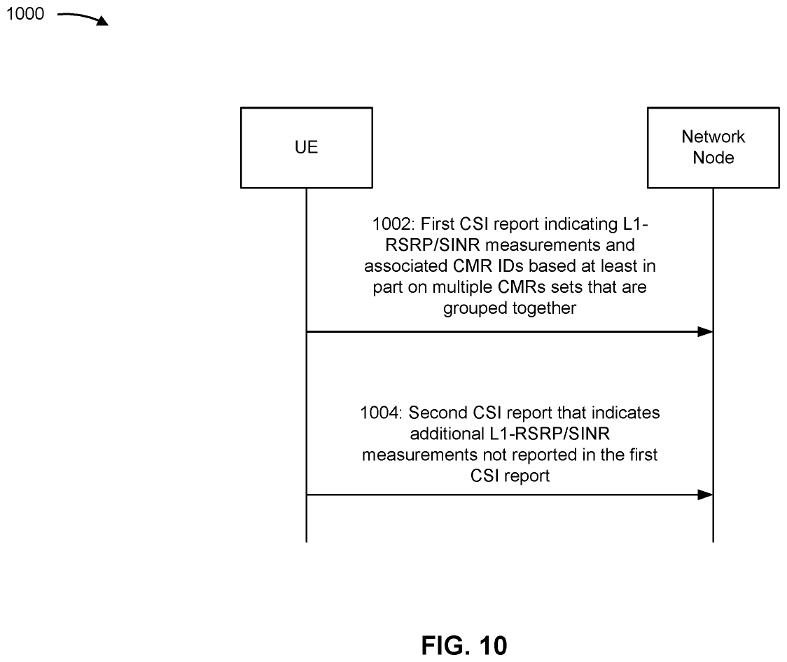

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 10-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 10-14).

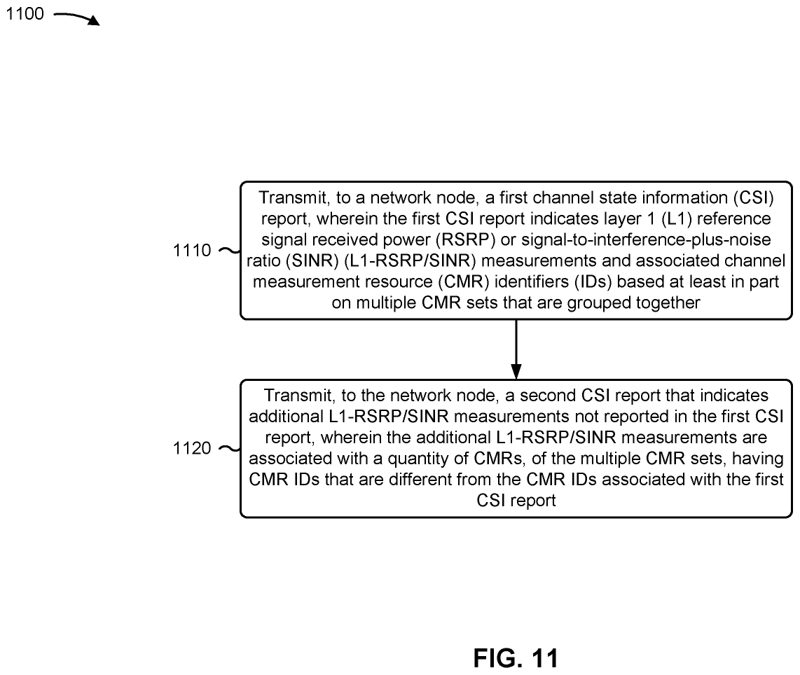

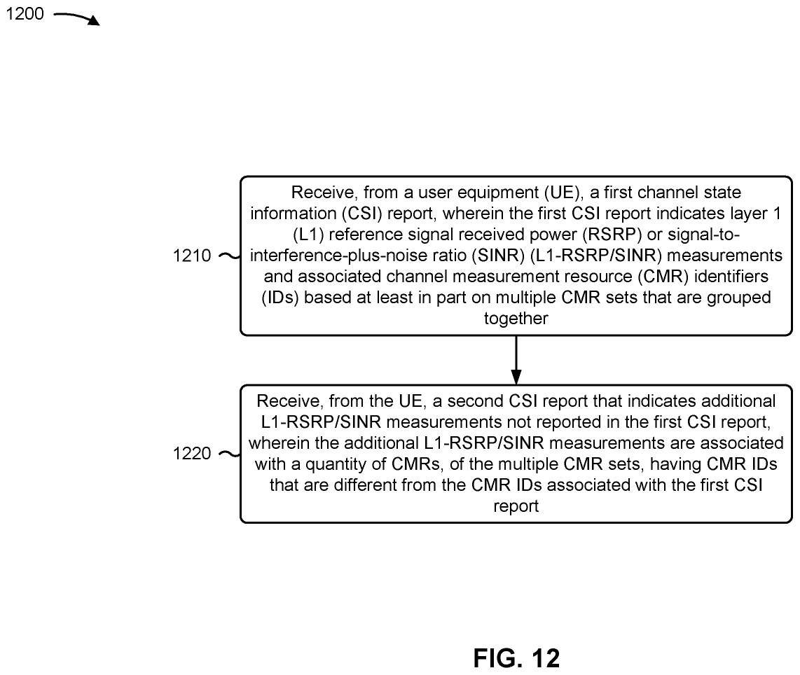

The controller/processor 240 of the network node 110, the controller/processor 280 of the UE 120, and/or any other component(s) of FIG. 2 may perform one or more techniques associated with CSI reporting for multiple CMR groups, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE (e.g., UE 120) includes means for transmitting, to a network node, a first CSI report, wherein the first CSI report indicates L1-RSRP/SINR measurements and associated CMR IDs based at least in part on multiple CMR sets that are grouped together; and/or means for transmitting, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for receiving, from a UE, a first CSI report, wherein the first CSI report indicates L1-RSRP/SINR measurements and associated CMR IDs based at least in part on multiple CMR sets that are grouped together; and/or means for receiving, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

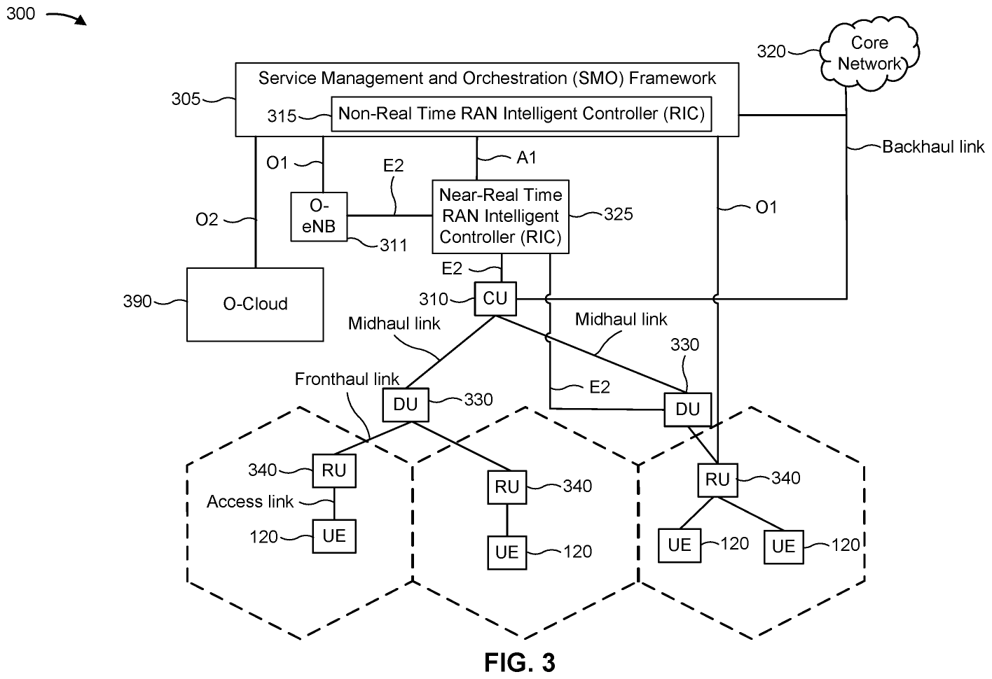

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

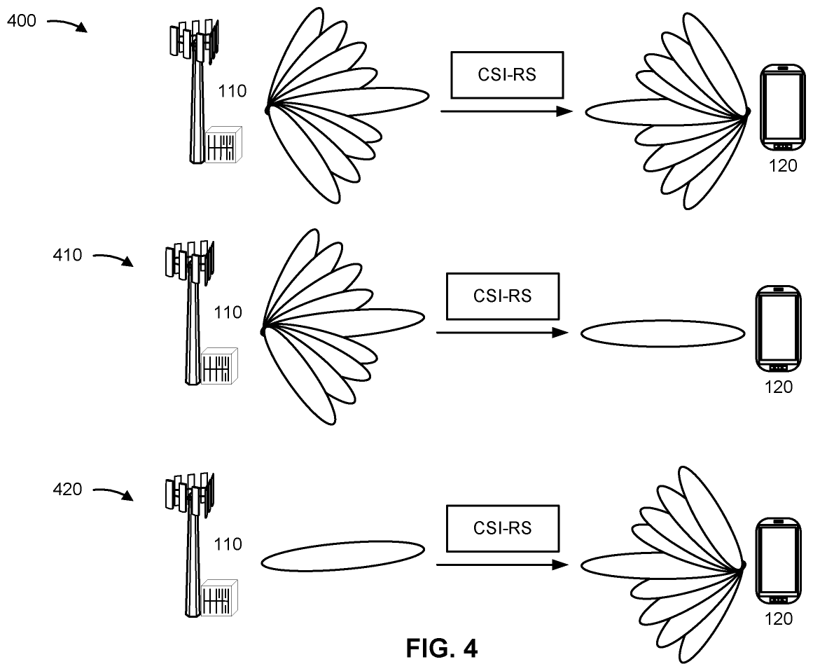

FIG. 4 is a diagram illustrating examples 400, 410, and 420 of beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 and a UE 120 communicating to perform beam management using channel state information reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 may sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 may sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

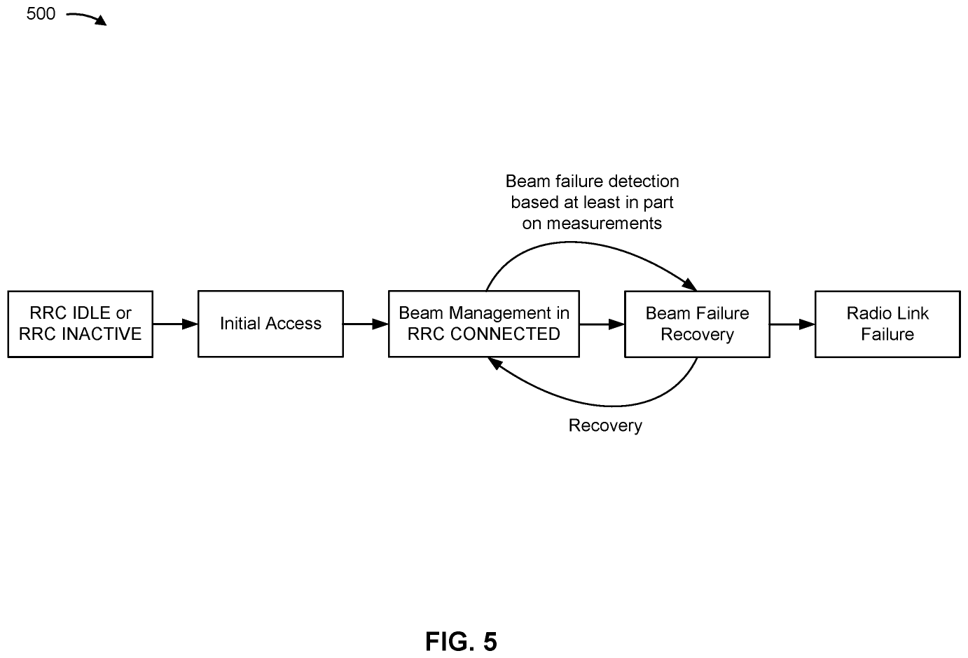

FIG. 5 is a diagram illustrating an example 500 of beam management, in accordance with the present disclosure.

As shown in FIG. 5, a UE may initially be in an RRC idle state or an RRC inactivate state. The UE may perform an initial access and beam management after entering an RRC connected state. The beam management may include P1, P2, and P3 beam management procedures, as described herein. The UE may also perform beam management using an AI/ML-based approach. The UE may perform a beam failure detection (BFD), and the UE may perform a beam failure recovery (BFR) based at least in part on the BFD. When the BFR is not successful, the UE may declare a radio link failure.

As indicated above, FIG. 5 is provided as an example. Other examples may differ from what is described with regard to FIG. 5.

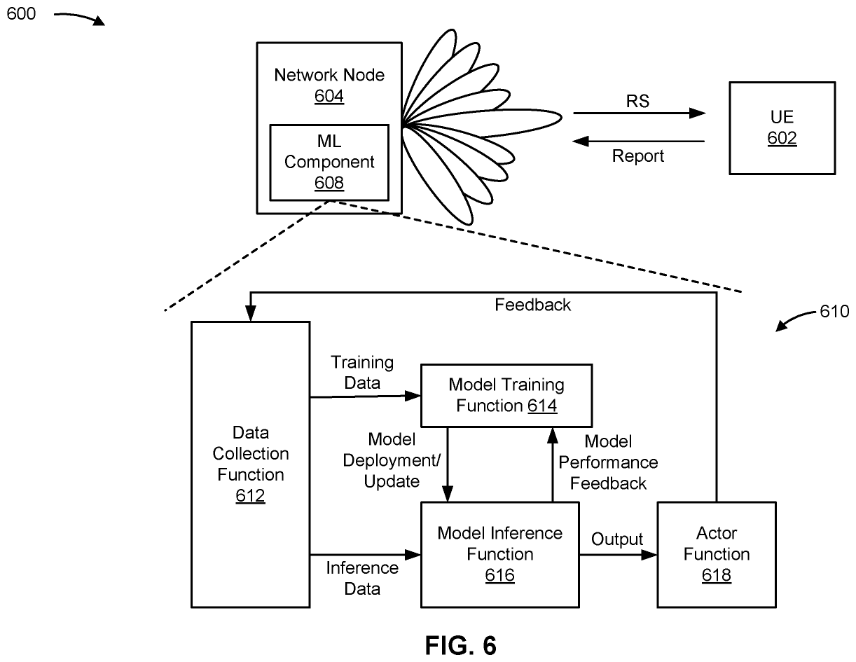

FIG. 6 is a diagram illustrating an example 600 of wireless communications, in accordance with the present disclosure.

As shown in FIG. 6, a network node 604 (e.g., network node 110) may communicate with a UE 602 (e.g., UE 120) to perform beam management using reference signals. The reference signals may include any number of different types of reference signals such as, for example, SSBs, CSI-RSs, sounding reference signals (SRSs), DMRSs, and/or beam failure detection reference signals (BFD-RSs), among other examples. Beam management may include any number of different procedures related to beams. For example, beam management may include beam sweeping procedures, SSB and random access channel (RACH) association, beam selection procedures, and/or beam refinement procedures, among other examples.

The network node 604 may transmit a reference signal (RS) and the UE 602 may receive the reference signal. The UE 602 may obtain one or more measurements associated with the reference signal and, based on the one or more measurements, may perform a wireless communication task. For example, the UE 602 may transmit a report to the network node 604 that reports the one or more measurements and/or information determined based on the one or more measurements. The UE 602 may adjust a wireless communication parameter based on the one or more measurements. In some cases, the network node 604 may perform one or more wireless communication tasks based on receiving the report from the UE 602.

The network node 604 may include a machine learning (ML) component 608. The ML component may include one or more ML models for facilitating wireless communication tasks. For example, ML models may be used to facilitate determining parameter values associated with measurements. An ML model may be used to estimate a group of parameters (e.g., interference and/or CSI, among other examples) from a common set of inputs (e.g., signal measurements) on current and/or future resources. For example, an ML model may jointly estimate the interference and the CSI on future resources using the same input CSI-RS. In another example, an ML model may estimate the interference on multiple future slots and/or symbols using the same input measurements.

In some cases, to develop a machine learning model of the ML component 608, the UE 602 may be configured to collect data and provide the collected data to the ML component 608. The ML component 608 may be configured to implement a functional framework 610 for developing the ML model. The functional framework 610 may include a data collection function 612, a model training function 614, a model inference function 616, and an actor function 618. The data collection function 612 may provide training data as input data to the model training function 614 and inference data as input to the model inference function 616. Examples of input data may include measurements from network nodes, feedback from the actor function 618, and/or output from an ML model. In some cases, the data collection function 612 may be configured to collect and provide data. For example, in some cases, the data collection function 612 may be configured so that ML-algorithm-specific data preparation (e.g., data pre-processing, data cleaning, data formatting, and/or transformation, among other examples) is not performed by the data collection function 612.

The model training function 614 may perform ML model training, validation, and/or testing, among other examples. The model training function 614 may also perform data preparation (e.g., data pre-processing, data cleaning, data formatting, and/or transformation, among other examples) based on training data delivered by the data collection function 612. The model training function 614 may deploy an ML model and/or an update of the ML model to the model inference function 616. The model inference function 616 may provide ML model inference output (e.g., predictions, classifications, estimations, and/or decisions, among other examples). In some cases, the model inference function 616 may provide model performance feedback to the model training function 614. The model inference function 616 may also perform data preparation (e.g., data pre-processing, data cleaning, data formatting, and/or transformation, among other examples) based on inference data delivered by the data collection function 612. The actor function 618 may receive the output from the model inference function 616 and perform one or more wireless communication tasks based on the output. The actor function 618 may provide feedback, which may be stored by the data collection function 612 for use as training data and/or inference data.

As indicated above, FIG. 6 is provided as an example. Other examples may differ from what is described with respect to FIG. 6.

AI/ML-based predictive beam management may involve beam management using AI/ML. One problem with traditional beam management procedures is that beam qualities/failures are always identified via measurements, which may require more power/overhead needed to achieve good performance. Further, beam accuracy may be limited due to restrictions on power/overhead, and latency/throughput may be impacted by beam resuming efforts. AI/ML-based predictive beam management may provide predictive beam management in a spatial domain, time domain, and/or frequency domain, which may result in power/overhead reduction and/or accuracy/latency/throughput improvement. AI/ML-based predictive beam management may predict non-measured beam qualities, which may result in lower power/overhead or better accuracy. For example, AI/ML-based predictive beam management may predict future beam blockage/failure, which may result in better latency/throughput. AI/ML-based predictive beam management may be useful because beam prediction is a highly non-linear problem. Predicting future Tx beam qualities may depend on a UE's moving speed/trajectory, Rx beams used or to be used, and/or interference, which may be difficult to model via conventional statistical signaling processing techniques.

AI/ML-based predictive beam management may involve the prediction of beams via AI/ML at the UE or at a network node, which may involve a tradeoff between performance and UE power. In order to predict future DL-Tx beam qualities, the UE may have more observations (via measurements) than the network node (via UE feedbacks). Thus, beam prediction at the UE may outperform beam prediction at the network node, but may involve more UE power consumption. Model training may occur at the network node or at the UE. For model training at the network node, data may be collected via an enhanced air interface or via application-layer approaches. For model training at the UE, additional UE computation/buffering efforts may be needed by model training and data storage.

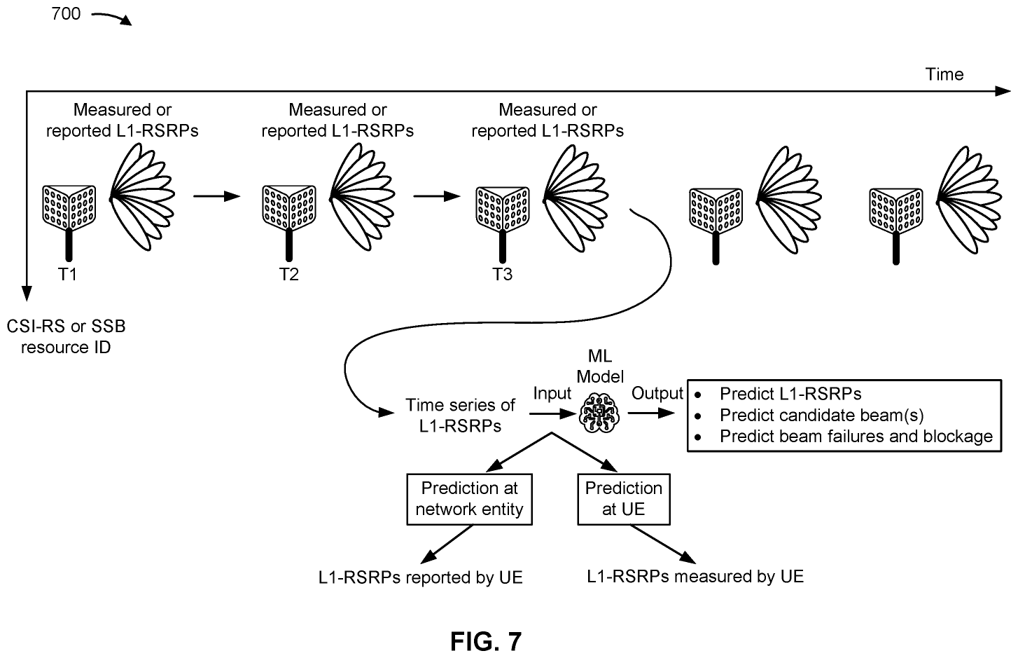

FIG. 7 is a diagram illustrating an example 700 of an AI/ML-based time domain beam prediction, in accordance with the present disclosure.

As shown in FIG. 7, in an AI/ML-based time domain beam prediction, a network node may, at a first time, transmit a plurality of first CSI-RSs/SSBs. The first CSI-RSs/SSBs may be associated with first CMRs. The UE may perform L1-RSRP/SINR measurements based at least in part on the plurality of first CSI-RSs/SSBs. The UE may report the first L1-RSRP/SINR measurements to the network node. The network node may, at a second time, transmit a plurality of second CSI-RSs/SSBs. The second CSI-RSs/SSBs may be associated with second CMRs. The UE may perform second L1-RSRP/SINR measurements based at least in part on the plurality of second CSI-RSs/SSBs. The UE may report the second L1-RSRP/SINR measurements to the network node. The network node may, at a third time, transmit a plurality of third CSI-RSs/SSBs. The third CSI-RSs/SSBs may be associated with third CMRs. The UE may perform third L1-RSRP/SINR measurements based at least in part on the plurality of third CSI-RSs/SSBs. The UE may report the third L1-RSRP/SINR measurements to the network node. A time series of L1-RSRP/SINR measurements (e.g., the first, second, and third L1-RSRP/SINR measurements) may be provided as an input to an ML model. When beam prediction is performed at the network node, the input may be L1-RSRP/SINR measurements reported by the UE. When the beam prediction is performed at the UE, the input may be L1-RSRP/SINR measurements measured by the UE. The ML model may produce an output based at least in part on the input, where the output may indicate a prediction of L1-RSRP/SINR measurements, a prediction of candidate beam(s), and/or a prediction of beam failure/blockage. The AI/ML-based time domain beam prediction may provide reduced UE power or UE-specific reference signal overhead, as well as better latency and throughput.

As indicated above, FIG. 7 is provided as an example. Other examples may differ from what is described with regard to FIG. 7.

L1 reporting may be supported in a multiple TRP configuration. A single channel state information (CSI) report consisting of N beam pairs/groups and M (where M is greater than one) beams per pair/group may be supported, and different beams within a pair/group may be received simultaneously. Two CMR resource sets or subsets may be defined per a periodic/semi-persistent CMR resource setting. Each reported beam pair in a single CSI report may consist of M=2 SSB resource indicator (SSBRI) or CSI-RS resource indicator (CRI) values, where each SSBRI/CRI may be associated with a CMR resource in a different CMR resource set or subset. A CMR resource set may be adopted over a subset. A bit width of each SSBRI/CRI may be based at least in part on a quantity of SSB/CSI-RS resources in an associated CMR resource set. A maximum quantity of beam groups in a single CSI report may be based at least in part on a UE capability, and may take a value from N max={1,2,3,4}. The quantity of beam groups (N) reported in a single CSI report may be configured via RRC signaling.

When associated with an aperiodic resource setting, an existing RRC parameter CSI-AssociatedReportConfigInfo may be extended to be configured with two CMR resource sets, where each CMR resource set may be configured with corresponding quasi co-location (QCL) information. When associated with a periodic/semi-persistent resource setting, a resource setting may include two CMR resource sets. In some cases, M>2 beams per group may or may not be supported for beam reporting.

A CSI report may include differential L1-RSRP/SINR reporting across a plurality of beam groups (e.g., all beam groups). The CSI report may include a one-bit indicator of the CMR set associated with a largest RSRP value in all beam groups, where a best beam may be assumed to be in a first beam group. One bit may indicate a CMR set with a higher RSRP value (e.g., “0” may indicate a first SSBRI/CRI from a first CMR set, and “1” may indicate a first SSBRI/CRI from a second CMR set). An uplink control information (UCI) payload partitioning may equal 7/4 bits for a first/second SSBRI/CRI in the first beam group, and may equal four bits for all beams in other beam groups.

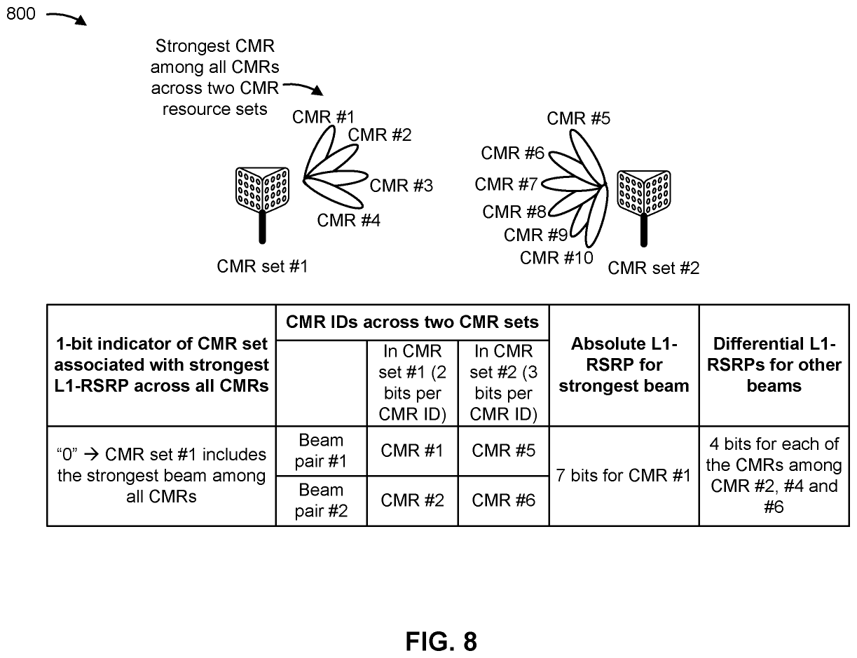

FIG. 8 is a diagram illustrating an example 800 of L1 reporting for multiple TRPs, in accordance with the present disclosure.

As shown in FIG. 8, in a UCI example in which N=2 beam pairs/groups and M=2 beams per pair/group, a one-bit indicator of a CMR set associated with a strongest L1-RSRP/SINR measurement across a plurality of CMRs (e.g., all CMRs) may be “0”,which may indicate that CMR set #1 includes the strongest beam among all CMRs. CMR identifiers (IDs) across two CMR sets may be defined. In CMR set #1 (2 bits per CMR ID), beam pair #1 may correspond to CMR #1, and beam pair #2 may correspond to CMR #6. A strongest CMR may be indicated by the first beam group/pair (e.g., beam pair #2). In CMR set #2 (3 bits per CMR ID), beam pair #1 may correspond to CMR #5, and beam pair #2 may correspond to CMR #6. CMR set #1 may be associated with a first TRP, and CMR set #2 may be associated with a second TRP. An absolute L1-RSRP measurement for the strongest beam may be associated with 7 bits for CMR #1. Differential L1-RSRP measurements for other beams may be associated with 4 bits for each of the CMRs among CMR #2, #5, and #6.

As indicated above, FIG. 8 is provided as an example. Other examples may differ from what is described with regard to FIG. 8.

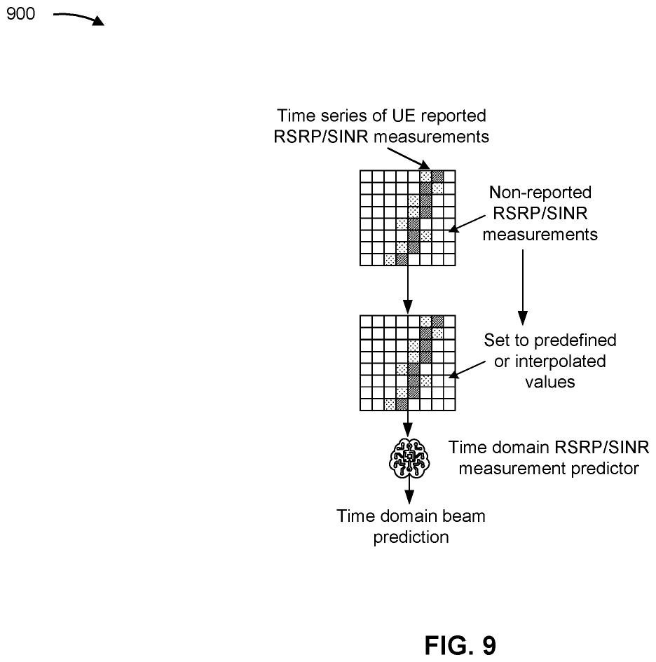

FIG. 9 is a diagram illustrating an example 900 of time domain beam prediction, in accordance with the present disclosure.

As shown by FIG. 9, a network node based time domain change/quality beam prediction may offload a UE AI/ML inference complexity and power consumption. An input to a time domain L1-RSRP/SINR measurement predictor, which may operate at the network node, may be UE reported L1-RSRP/SINR measurements via a background periodic channel state information (P-CSI) report with an extended periodicity (e.g., 80 ms). The network node may receive a time series of UE reported L1-RSRP/SINR measurements. Some L1-RSRP/SINR measurements may not be reported by the UE. The L1-RSRP/SINR measurements with respect to non-reported reference signals may be set to predefined values, or the L1-RSRP/SINR measurements may be determined based at least in part on interpolated/predicted values.

Since the L1-RSRP/SINR measurements with respect to non-reported reference signals may need to be set to predefined values or interpolated/predicted values, a confidence level of predicted L1-RSRP/SINR measurements may be degraded. The confidence level may be captured via an L1-RSRP/SINR measurement variance prediction. On the other hand, constantly reporting L1-RSRP/SINR measurements with respect to a plurality of beams (e.g., all beams) may increase an overhead and/or degrade a delivery reliability of the reports.

A low confidence level of predicted L1-RSRP/SINR measurements may be due to several reasons. First, the low confidence level may be due to a beam change that will happen. Second, the low confidence level may be due to a lack of L1-RSRP/SINR measurements regarding those non-reported reference signals. In other words, the low confidence level may be due to an insufficient input of L1-RSRP/SINR measurements due to the non-reported L1-RSRP/SINR measurements. The network node may trigger semi-persistent or aperiodic L1-RSRP/SINR measurement reports more frequently as compared to background periodic CSI-reports, or the network node may dynamically trigger redundant L1-RSRP/SINR measurement reports. The network node may dynamically trigger aperiodic L1-RSRP/SINR measurement reports to request the UE to report all/some of the missing L1-RSRP/SINR measurements.

As indicated above, FIG. 9 is provided as an example. Other examples may differ from what is described with respect to FIG. 9.

In order to address an uncertainty issue with ML-based time domain beam prediction in terms of input L1-RSRP/SINR measurements, a UE may be configured with a second aperiodic CSI report associated with a first periodic or semi-persistent CSI report, whose report quantity may include at least L1-RSRP/SINR measurements of K CMRs, which may be different from CMR IDs in the first periodic or semi-persistent CSI report (e.g., a most recently reported first periodic or semi-persistent CSI report). “K CMRs” may be referred to interchangeably with “quantity of CMRs” herein.

However, when CMR-pairwise L1 reporting schemes for multiple TRPs are considered for time domain beam prediction regarding the beams from the multiple TRPs, such an approach cannot be straightforwardly applied, since additional CMRs to be addressed in the dynamically triggered aperiodic L1 report may be determined based on an assumption that only a single CMR set was assumed in a background periodic or semi-persistent CSI report. When multiple CMR sets are considered, as in multiple TRP L1 reporting, which additional CMRs to be addressed needs to be defined.

As an example, a network node may determine that a predicted beam quality for a first TRP is favorable, but the network node may be unable to determine whether a predicted beam quality for a second TRP is favorable. Thus, the network node may be interested only in triggering aperiodic L1 reports requesting for additional L1-RSRP/SINR measurements regarding CMRs with respect to the second TRP, and not with respect to the first TRP. In this case, a UE must be able to determine which additional CMRs are to be addressed in an additional aperiodic CSI report.

In various aspects of techniques and apparatuses described herein, a UE may transmit, to a network node, a first CSI report. The network node may be associated with a first TRP and a second TRP. The first CSI report may be a periodic CSI report, a semi-persistent CSI report, or an aperiodic CSI report. The first CSI report may indicate L1-RSRP/SINR measurements and associated CMR IDs based at least in part on multiple CMR sets that are grouped together. The UE may transmit, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report. The second CSI report may be an aperiodic CSI report. The UE may select the quantity of CMRs from one of the multiple CMR sets, or from multiple CMR subsets of the multiple CMR sets. The second CSI report that indicates the additional L1-RSRP/SINR measurements may be for a predictive beam management for multiple TRPs, which may include the first TRP and the second TRP. As a result, in a multiple TRP configuration, the UE may be able to report the additional L1-RSRP/SINR measurements for a selected quantity of CMRs, or the multiple CMRs. In some aspects, the UE may perform additional signaling to support dynamically triggered additional L1-RSRP/SINR measurement reporting for predictive beam management for the multiple TRPs.

FIG. 10 is a diagram illustrating an example 1000 associated with CSI reporting for multiple CMR groups, in accordance with the present disclosure. As shown in FIG. 10, example 1000 includes communication between a UE (e.g., UE 120) and a network node (e.g., network node 110). In some aspects, the UE and the network node may be included in a wireless network, such as wireless network 100.

As shown by reference number 1002, the UE may transmit, to the network node, a first CSI report. The first CSI report may be a periodic CSI report, a semi-persistent CSI report, or an aperiodic CSI report. The first CSI report may indicate L1-RSRP/SINR measurements and associated CMR IDs based at least in part on multiple CMR sets that are grouped together. The network node may be associated with a first TRP and a second TRP.

As shown by reference number 1004, the UE may transmit, to the network node, a second CSI report that indicates additional L1-RSRP/SINR measurements not reported in the first CSI report. The second CSI report may be a dynamically triggered aperiodic CSI report. The additional L1-RSRP/SINR measurements may be associated with a quantity of CMRs, of the multiple CMR sets, having CMR IDs that are different from the CMR IDs associated with the first CSI report. In some aspects, the UE may select the quantity of CMRs from one of the multiple CMR sets, or the UE may select the quantity of CMRs from multiple CMR subsets of the multiple CMR sets. In some aspects, the second CSI report may be triggered to indicate the additional L1-RSRP/SINR measurements for the quantity of CMRs associated with the second TRP, based at least in part on a predicted beam quality for the first TRP satisfying a threshold and a predicted beam quality for the second TRP not satisfying the threshold. The second CSI report that indicates the additional L1-RSRP/SINR measurements may be for a predictive beam management for multiple TRPs which include the first TRP and the second TRP.

In some aspects, additional aperiodic L1-RSRP/SINR measurement reports, which may be dynamically triggered by the network node, may be supported for CMR-pairwise L1 reports in a multiple TRP beam management. In a multiple TRP L1 report, the UE may be configured (or activated or triggered), by the network node, to provide the first CSI report to the network node. The first CSI report may be a periodic, semi-persistent, or aperiodic CSI report. The first CSI report may have a report quantity that includes at least L1-RSRP/SINR measurements and associated CMR IDs, which may be based at least in part on multiple CMR sets grouped with each other. The UE may explicitly indicate, to the network node, which CMR set includes the strongest CMR among all measured CMRs. The UE may further report, to the network node, N CMR ID groups (M CMR IDs per group), where CMR IDs with each “base” CMR ID group may be selected from respective CMR sets. The strongest CMR ID may be reported (e.g., always reported) within a first “base” CMR ID group. The UE may further report, to the network node, an absolute L1-RSRP/SINR measurement value of the strongest “base” CMR, and then report differential L1-RSRP/SINR measurement values of other CMRs. In some aspects, the UE may be further triggered, by the network node, to provide the second CSI report to the network node. The second CSI report may be an aperiodic CSI report, and the second CSI report may be associated with the first CSI report. The second CSI report may have a report quantity that includes at least L1-RSRP/SINR measurements of K CMRs that are different from CMR IDs in the first CSI report (e.g., a most recently reported first CSI report). The UE may select the K CMRs from at most one of the total multiple CMR sets. The UE may select the K CMRs from multiple CMR subsets of the total multiple CMR sets. The UE may arbitrarily select the K CMRs from the total multiple CMR sets.

In some aspects, pair-wise reported L1-RSRP/SINR measurements via the first CSI report may be based at least in part on two different CMR sets. For example, a first CMR set may include CMR #1, CMR #2, CMR #3, and CMR #4. The first CMR set may be associated with the first TRP. A second CMR set may include CMR #5, CMR #6, CMR #7, CMR #8, CMR #9, and CMR #10. The second CMR set may be associated with the second TRP. The second CSI report (e.g., an aperiodic CSI report) may be triggered after the first CSI report. The second CSI report may be for additional L1-RSRP/SINR measurements not reported in the first CSI report. The UE may determine which CMRs should be addressed in the second CSI report. The UE may select one or a subset of the total multiple CMR sets (e.g., beams from such CMR sets may be predicted to be less certain). Alternatively, the UE may arbitrarily select from the total multiple CMR sets.

In some aspects, the UE may select the quantity of CMRs from identified CMR sets of the multiple CMR sets based at least in part on an aperiodic CSI triggering state configuration. The aperiodic CSI triggering state configuration may indicate: a first CSI report setting ID associated with the first CSI report, and one or more CMR set IDs, of CMR set IDs associated with the multiple CMR sets, associated with the first CSI report setting, where the quantity of CMRs may be selected from the identified CMR sets associated with the one or more CMR set IDs based at least in part on a triggering of the second CSI report.

In some aspects, the UE may determine that K additional CMRs should be selected from specific CMR set(s), which may be explicitly configured through an aperiodic CSI triggering state. A CSI associated report configuration information (CSI-AssociatedReportConfigInfo) information element (IE) may be associated with a preconfigured CSI triggering state including a CSI report setting associated with the second CSI report. The CSI-AssociatedReportConfigInfo IE may include a first CSI report setting ID associated with the first CSI report. The CSI-AssociatedReportConfigInfo IE may include one or more CMR set IDs out of the total multiple CMR sets associated with the first CSI report setting, such that the K additional CMRs should be selected from such configured CMR sets, upon the associated second CSI report being triggered.

In some aspects, a first aperiodic CSI triggering state configuration may include a CSI report setting ID with respect to the first CSI report, and additional L1-RSRP/SINR measurements may be selected from a first CMR set associated with the first CSI report. A second aperiodic CSI triggering state configuration may include a CSI report setting ID with respect to the first CSI report, and additional L1-RSRP/SINR measurements may be selected from a second CMR set associated with the first CSI report. The second CSI report may be triggered, in an aperiodic manner, with respect to certain triggering states. The UE may determine which CMR set is to be addressed by additional L1-RSRP/SINR measurements. The second CSI report may be triggered after the first CSI report, where the second CSI report may indicate the additional L1-RSRP/SINR measurements not reported in the first CSI report.

In some aspects, the UE may select the quantity of CMRs from one or more of the multiple CMR sets based at least in part on an explicit indication using dedicated fields in an uplink grant DCI triggering the second CSI report. The dedicated fields may include one or more CMR set IDs, of CMR set IDs associated with the multiple CMR sets, associated with a first CSI report setting, where the quantity of CMRs may be selected from one or more CMR sets associated with the one or more CMR set IDs based at least in part on a triggering of the second CSI report. The dedicated fields may include a first CSI report setting ID associated with the first CSI report.

In some aspects, the UE may determine that K additional CMRs should be selected from specific CMR set(s), which may be explicitly indicated through dedicated fields in an uplink grant downlink control information (DCI) triggering the second CSI report (e.g., the aperiodic CSI report). The uplink grant DCI triggering the second CSI report may include dedicated field(s) indicating one or more CMR set IDs out of the total multiple CMR sets associated with the first CSI report setting, such that the K additional CMRs may be selected from such configured CMR sets, upon the associated second CSI report being triggered. In this case, the first CSI report setting ID associated with the first CSI report may be configured by the CSI-AssociatedReportConfigInfo IE associated with a preconfigured CSI triggering state including the CSI report setting associated with the second CSI report. When multiple second CSI reports are triggered by a same uplink grant DCI, the UE may assume that all of the multiple second CSI reports follow the same CMR set selection rules indicated by such dedicated field(s). In some aspects, the dedicated field(s) may indicate the first CSI report setting ID associated with the first CSI report. In this case, the UE may only apply such CMR set selection rules indicated by the dedicated field(s), to be associated with the most recently reported first CSI report and the associated total multiple CMR sets with respect to the CSI report setting ID also indicated in the dedicated field(s). The UE may assume that all second CSI reports, where associated CMRs of such second CSI reports are in the same component carrier as the CMRs associated with the first CSI report, that are triggered by such uplink grant DCI are regarding such new type of reports for additional L1-RSRP/SINR measurements.

In some aspects, the uplink grant DCI triggering the second CSI report (e.g., the aperiodic CSI report) may include dedicated fields, from which the UE may determine which CMR set is to be addressed by additional L1-RSRP/SINR measurements. The UE may transmit the second CSI report, which may indicate the additional L1-RSRP/SINR measurements, which are not reported in the first CSI report.

In some aspects, the UE may select the quantity of CMRs from one or more of the multiple CMR sets based at least in part on an implicit identification from a Type-D source reference signal of a control resource set (CORESET) carrying an uplink grant DCI triggering the second CSI report, where the uplink grant DCI may be received using the Type-D source reference signal of the CORESET that is quasi co-located with one or more CMRs from a first CMR set of the multiple CMR sets. The quantity of CMRs may be selected from CMR sets other than the first CMR set of the multiple CMR sets, or the quantity of CMRs may be selected from the first CMR set. In some aspects, the UE may select the quantity of CMRs from all of the multiple CMR sets.

In some aspects, the UE may determine that K additional CMRs should be selected from specific CMR set(s), which may be implicitly identified from a Type-D source reference signal of a CORESET carrying the uplink grant DCI triggering the second CSI report. When the uplink grant DCI triggering the second CSI report is received from a CORESET Type-D quasi co-located with a source reference signal that is quasi co-located with one of the CMRs from a first CMR set within the total multiple CMR sets, the UE may select the K additional CMRs from the CMR sets other than the first CMR set, out of the total multiple CMR sets. The network node may want to signal such uplink grant DCI from a TRP whose time domain predicted beams are more certain. When more than one CMR set is remaining, other than the first CMR set, the UE may select the K additional CMRs from all of the remaining CMR sets. The UE may select the K additional CMRs from one of the remaining CMR sets, whose strongest L1-RSRP/SINR measurement may be the weakest one among all strongest L1-RSRP/SINR measurements of the other remaining CMR sets. In some aspects, the UE may select the K additional CMRs from the first CMR set. In some aspects, the UE may select the K additional CMRs from all of the total multiple CMR sets, which may be a default setting when no additional signaling is carried. However, the first CSI report setting ID associated with the first CSI report may still be configured by the CSI-AssociatedReportConfigInfo IE associated with a preconfigured CSI triggering state including the CSI report setting associated with the second CSI report.

In some aspects, the uplink grant DCI may trigger the second CSI report. The uplink grant DCI may be associated with the CORESET, which may be quasi co-located with one of the CMRs (e.g., CMR #1 of a first CMR set, where the first CMR set may include CMR #1, CMR #2, CMR #3, and CMR #4) from the first CMR set, out of the total multiple CMR sets. The first CMR set may be associated with the first TRP. A second CMR set may be addressed by additional L1-RSRP/SINR measurements, since a quality of the second CMR set is more likely to be worse than the first CMR set due to the uplink grant DCI being received from the first TRP and not from the second TRP, which may be associated with the second CMR set. The UE may transmit the second CSI report, which may indicate the additional L1-RSRP/SINR measurements not reported in the first CSI report.

In some aspects, the UE may select the quantity of CMRs based at least in part on remaining strongest CMRs within identified CMR sets. The UE may select the quantity of CMRs based at least in part on remaining weakest CMRs within the identified CMR sets. The UE may select the quantity of CMRs based at least in part on remaining CMRs within a certain RSRP/SINR range. The UE may select the quantity of CMRs based at least in part on all remaining CMRs. The UE may select the quantity of CMRs based at least in part on an explicit indication, received from the network node, that triggers the second CSI report. The UE may select the quantity of CMRs based at least in part on a standard predefinition or a configuration received from the network node, where the configuration may indicate a value of the quantity of CMRs (e.g., a value of K).

In some aspects, the UE may determine the K CMRs based at least in part on a standard predefinition, or a network node configuration/indication, which may include a value of K. In some aspects, the UE may determine the K CMRs based at least in part on remaining strongest CMRs. The UE may first identify CMRs reported in the first CSI report (e.g., the most recent first persistent or semi-persistent CSI report), and then the UE may further identify the K remaining strongest CMRs associated with the same measurement occasion, within only the identified CMR sets. In some aspects, the UE may determine the K CMRs based at least in part on remaining weakest CMRs. The UE may identify the remaining weakest CMRs associated with the same measurement occasion as the first CSI report (e.g., the most recent first persistent or semi-persistent CSI report), within only the identified CMR sets. In some aspects, the UE may determine the K CMRs based at least in part on remaining CMRs within a certain RSRP/SINR measurement range. The UE may identify a differential RSRP/SINR measurement range, which may be based at least in part on a standard predefinition or a network node pre-configuration, referring to the weakest RSRP/SINR measurement reported in the first CSI report (e.g., the most recent first persistent or semi-persistent CSI report), within only the identified CMR sets. The UE may further report, to the network node, at most K CMRs and corresponding RSRP/SINR measurements, whose RSRP/SINR measurements are within such a differential RSRP/SINR range. In some aspects, the UE may determine the K CMRs based at least in part on all remaining CMRs, within only the identified CMR sets. In some aspects, CMR IDs may be explicitly and dynamically indicated by the network node while triggering the second CSI report, within only the identified CMR sets.

In some aspects, the UE may perform a quantization of the additional L1-RSRP/SINR measurements associated with the quantity of CMRs included in the second CSI report. The additional L1-RSRP/SINR measurements may be quantized differentially referring to a strongest or weakest L1-RSRP/SINR measurement in the first CSI report. The additional L1-RSRP/SINR measurements may be quantized differentially referring to a strongest or weakest L1-RSRP/SINR measurement within selected CMR sets within the first CSI report. A strongest additional L1-RSRP/SINR measurement, carried in the second CSI report, may be quantized absolutely, and remaining additional L1-RSRP/SINR measurements of the second CSI report may be quantized differentially referring to the strongest additional L1-RSRP/SINR measurement carried in the second CSI report. A first portion of additional L1-RSRP/SINR measurements may be quantized using a first mechanism and a second portion of additional L1-RSRP/SINR measurements may be quantized using a second mechanism that is different from the first mechanism.

In some aspects, a quantization of RSRP/SINR measurements regarding the K CMRs may be based on one of several options. In a first option, which may provide lower overhead, a plurality of RSRP/SINR measurements (e.g., all RSRP/SINR measurements) regarding the K CMRs carried in the second CSI report may be quantized differentially referring to the strongest/weakest RSRP/SINR measurement within the first CSI report. In a variation of the first option, all RSRP/SINR measurements regarding the K CMRs carried in the second CSI report may be quantized differentially referring to the strongest/weakest RSRP/SINR within selected CMR set(s) within the first CSI report. In a second option, which may provide better granularity, the strongest RSRP/SINR measurement within the second CSI report may be quantized absolutely, while remaining RSRP/SINR measurements may be quantized differentially referring to the strongest/weakest RSRP/SINR measurement also carried in the second CSI report. In a third option, which may provide a compromise between overhead and granularity, some RSRP/SINR measurements may be quantized using the first option and other RSRP/SINR measurements may be quantized using the second option. As an example, the network node may request the UE to report both remaining strongest RSRP/SINR measurements and remaining weakest RSRP/SINR measurements. The UE may be standard-predefined or configured by the network node to quantize the remaining strongest RSRP/SINR measurements via the first option and quantize the remaining weakest RSRP/SINR measurements via the second option. In a variation of the third option, some RSRP/SINR measurements may be quantized using the variation of the first option, while other RSRP/SINR measurements may be quantized using the second option. As an example, the network node may request the UE to report both remaining strongest RSRP/SINR measurements and remaining weakest RSRP/SINR measurements. The UE may be standard predefined or configured by the network node to report the remaining strongest RSRP/SINR measurements, while the remaining weakest RSRP/SINR measurements may be quantized.

In some aspects, the UE may use one of the options (or variations of the options) based at least in part on a standard pre-definition, which may be based at least in part on associations between different options. For example, when the UE is reporting the remaining strongest RSRP/SINR measurements, a certain option may be used. As another example, when the UE is reporting the remaining weakest RSRP/SINR measurements, a certain may be used. In some aspects, the UE may use one of the options based at least in part on a network node pre-configuration. For example, the network node may configure the UE to use one of the options for an associated second CSI report. In some aspects, the UE may use one of the options based at least in part on a dynamic indication received from the network node. For example, the network node may indicate one of the options when triggering the second CSI report.

In some aspects, the UE may receive, from the network node, a CSI associated report configuration that indicates one or more of: one or more CMR set IDs, of CMR set IDs associated with the multiple CMR sets, associated with a first CSI report setting, where the one or more CMR set IDs may indicate the quantity of CMRs to be addressed in the second CSI report; a CSI report setting ID associated with the first CSI report, where the CSI report setting ID may indicate the first CSI report that is to be associated with the second CSI report; a determination scheme for determining the quantity of CMRs; and a quantization scheme for quantizing the additional L1-RSRP/SINR measurements associated with the quantity of CMRs. In some aspects, the UE may receive, from the network node, a CSI associated report configuration that indicates a CSI report setting ID associated with the first CSI report, where the CSI report setting ID may indicate the first CSI report that is to be associated with the second CSI report. The UE may receive, from the network node, dedicated fields within an uplink grant DCI, where the dedicated fields may indicate: one or more CMR set IDs, of CMR set IDs associated with the multiple CMR sets, associated with a first CSI report setting, where the one or more CMR set IDs may indicate the quantity of CMRs to be addressed in the second CSI report; a determination scheme for determining the quantity of CMRs; and/or a quantization scheme for quantizing the additional L1-RSRP/SINR measurements associated with the quantity of CMRs.

In some aspects, based at least in part on an aperiodic CSI triggering state enhancement, the CSI-AssociatedReportConfigInfo IE associated with a preconfigured CSI triggering state may include the CSI report setting associated with the second CSI report. The CSI-AssociatedReportConfigInfo IE may include a CMR set selection information (cmrSetSelectionInfo) parameter, which may indicate which CMR set(s) the K additional CMRs should be addressed in the second CSI report (e.g., one or more CMR set IDs out of the total multiple CMR sets associated with the first CSI report setting). The CSI-AssociatedReportConfigInfo IE may include a CSI report configuration ID (CSI-ReportConfigId) parameter, which may indicate which first CSI report is to be focused on the triggered second CSI report (e.g., a CSI report setting ID associated with the first CSI report). The CSI-AssociatedReportConfigInfo IE may include a remaining CMR determination (RemainingCMRDetermination) parameter, which may indicate detailed schemes for determining the K CMRs. The CSI-AssociatedReportConfigInfo IE may include a quantization scheme for remaining CMRs (quantizationSchemeForRemainingCMRs) parameter, which may indicate detailed quantization schemes for the K L1-RSRP/SINR measurements. In some aspects, the CSI-AssociatedReportConfigInfo IE may include the CSI report setting ID associated with the first CSI report.

In some aspects, based at least in part on an RRC signaling and uplink grant DCI enhancement, the CSI-AssociatedReportConfigInfo IE associated with a preconfigured CSI triggering state may include the CSI report setting associated with the second CSI report. The CSI-AssociatedReportConfigInfo IE may include the CSI report setting ID associated with the first CSI report. The uplink grant DCI may include dedicated field(s). The dedicated field(s) may indicate one or more CMR set IDs out of the total multiple CMR sets associated with the first CSI report setting. The dedicated field(s) may indicate the CSI report setting ID associated with the first CSI report (when not configured by the aperiodic CSI triggering state). The dedicated field(s) may indicate a determination scheme of the K CMRs. The dedicated field(s) may indicate a quantization scheme of the K L1-RSRP/SINR measurements.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120) performs operations associated with CSI reporting for multiple CMR groups.

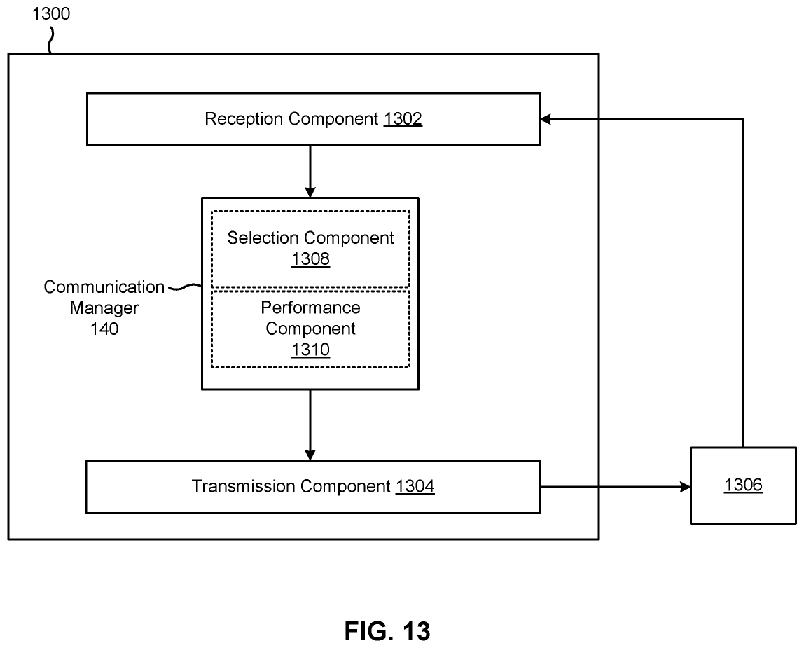

As shown in FIG. 11, in some aspects, process 1100 may include transmitting, to a network node, a first CSI report, wherein the first CSI report indicates L1-RSRP/SINR measurements and associated CMR IDs based at least in part on multiple CMR sets that are grouped together (block 1110). For example, the UE (e.g., using communication manager 140 and/or transmission component 1304, depicted in FIG. 13) may transmit, to a network node, a first CSI report, wherein the first CSI report indicates L1-RSRP/SINR measurements and associated CMR IDs based at least in part on multiple CMR sets that are grouped together, as described above.

As further shown in FIG. 11, in some aspects, process 1100 may include transmitting, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report (block 1120). For example, the UE (e.g., using communication manager 140 and/or transmission component 1304, depicted in FIG. 13) may transmit, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report, as described above.

Process 1100 may include additional aspects, such as any single aspect or any combination of aspects described below and/or in connection with one or more other processes described elsewhere herein.

In a first aspect, the first CSI report is a periodic CSI report, a semi-persistent CSI report, or an aperiodic CSI report, and the second CSI report is an aperiodic CSI report that is dynamically triggered by the network node.

In a second aspect, alone or in combination with the first aspect, process 1100 includes selecting the quantity of CMRs from one of the multiple CMR sets, or selecting the quantity of CMRs from multiple CMR subsets of the multiple CMR sets.

In a third aspect, alone or in combination with one or more of the first and second aspects, process 1100 includes selecting the quantity of CMRs from identified CMR sets of the multiple CMR sets based at least in part on aperiodic CSI triggering state configuration, wherein the aperiodic CSI triggering state configuration indicates a first CSI report setting ID associated with the first CSI report, and one or more CMR set IDs, of CMR set IDs associated with the multiple CMR sets, associated with the first CSI report setting, and the quantity of CMRs are selected from the identified CMR sets associated with the one or more CMR set IDs based at least in part on a triggering of the second CSI report.

In a fourth aspect, alone or in combination with one or more of the first through third aspects, process 1100 includes selecting the quantity of CMRs from one or more of the multiple CMR sets based at least in part on an explicit indication using dedicated fields in an uplink grant DCI triggering the second CSI report, wherein the dedicated fields include one or more CMR set IDs, of CMR set IDs associated with the multiple CMR sets, associated with a first CSI report setting, and the quantity of CMRs are selected from one or more CMR sets associated with the one or more CMR set IDs based at least in part on a triggering of the second CSI report, and a first CSI report setting ID associated with the first CSI report.

In a fifth aspect, alone or in combination with one or more of the first through fourth aspects, process 1100 includes selecting the quantity of CMRs from one or more of the multiple CMR sets based at least in part on an implicit identification from a Type-D source reference signal of a CORESET carrying an uplink grant DCI triggering the second CSI report, wherein the uplink grant DCI is received using the Type-D source reference signal of the CORESET that is quasi co-located with one or more CMRs from a first CMR set of the multiple CMR sets, wherein the quantity of CMRs are selected from CMR sets other than the first CMR set of the multiple CMR sets, or wherein the quantity of CMRs are selected from the first CMR set.

In a sixth aspect, alone or in combination with one or more of the first through fifth aspects, process 1100 includes selecting the quantity of CMRs from all of the multiple CMR sets.

In a seventh aspect, alone or in combination with one or more of the first through sixth aspects, process 1100 includes selecting the quantity of CMRs based at least in part on remaining strongest CMRs within identified CMR sets, selecting the quantity of CMRs based at least in part on remaining weakest CMRs within the identified CMR sets, selecting the quantity of CMRs based at least in part on remaining CMRs within a certain RSRP/SINR range, selecting the quantity of CMRs based at least in part on all remaining CMRs, or selecting the quantity of CMRs based at least in part on an explicit indication, received from the network node, that triggers the second CSI report.

In an eighth aspect, alone or in combination with one or more of the first through seventh aspects, process 1100 includes selecting the quantity of CMRs based at least in part on a standard predefinition or a configuration received from the network node, wherein the configuration indicates a value associated with the quantity of CMRs.

In a ninth aspect, alone or in combination with one or more of the first through eighth aspects, process 1100 includes performing a quantization of the additional L1-RSRP/SINR measurements associated with the quantity of CMRs included in the second CSI report, wherein the additional L1-RSRP/SINR measurements are quantized differentially referring to a strongest or weakest L1-RSRP/SINR measurement in the first CSI report, the additional L1-RSRP/SINR measurements are quantized differentially referring to a strongest or weakest L1-RSRP/SINR measurement within selected CMR sets within the first CSI report, a strongest additional L1-RSRP/SINR measurement, carried in the second CSI report, is quantized absolutely, and remaining additional L1-RSRP/SINR measurements of the second CSI report are quantized differentially referring to the strongest additional L1-RSRP/SINR measurement carried in the second CSI report, or a first portion of additional L1-RSRP/SINR measurements are quantized using a first mechanism and a second portion of additional L1-RSRP/SINR measurements are quantized using a second mechanism that is different from the first mechanism.

In a tenth aspect, alone or in combination with one or more of the first through ninth aspects, process 1100 includes receiving, from the network node, a CSI associated report configuration that indicates one or more of one or more CMR set IDs, of CMR set IDs associated with the multiple CMR sets, associated with a first CSI report setting, wherein the one or more CMR set IDs indicate the quantity of CMRs to be addressed in the second CSI report, a CSI report setting ID associated with the first CSI report, and the CSI report setting ID indicates the first CSI report that is to be associated with the second CSI report, a determination scheme for determining the quantity of CMRs, or a quantization scheme for quantizing the additional L1-RSRP/SINR measurements associated with the quantity of CMRs.

In an eleventh aspect, alone or in combination with one or more of the first through tenth aspects, process 1100 includes receiving, from the network node, a CSI associated report configuration that indicates a CSI report setting ID associated with the first CSI report, wherein the CSI report setting ID indicates the first CSI report that is to be associated with the second CSI report, and receiving, from the network node, dedicated fields within an uplink grant DCI, wherein the dedicated fields indicate one or more of one or more CMR set IDs, of CMR set IDs associated with the multiple CMR sets, associated with a first CSI report setting, wherein the one or more CMR set IDs indicate the quantity of CMRs to be addressed in the second CSI report, a determination scheme for determining the quantity of CMRs, or a quantization scheme for quantizing the additional L1-RSRP/SINR measurements associated with the quantity of CMRs.

In a twelfth aspect, alone or in combination with one or more of the first through eleventh aspects, the network node is associated with a first TRP and a second TRP, and the second CSI report is triggered to indicate the additional L1-RSRP/SINR measurements for the quantity of CMRs associated with the second TRP, based at least in part on a predicted beam quality for the first TRP satisfying a threshold and a predicted beam quality for the second TRP not satisfying the threshold.

In a thirteenth aspect, alone or in combination with one or more of the first through twelfth aspects, the second CSI report that indicates the additional L1-RSRP/SINR measurements is for a predictive beam management for multiple TRPs.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with CSI reporting for multiple CMR groups.

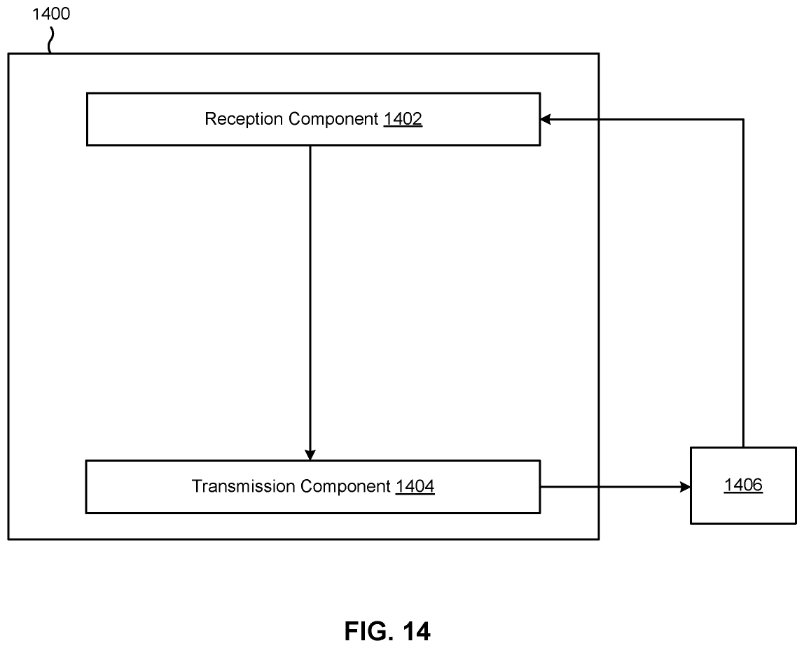

As shown in FIG. 12, in some aspects, process 1200 may include receiving, from a UE, a first CSI report, wherein the first CSI report indicates L1-RSRP/SINR measurements and associated CMR IDs based at least in part on multiple CMR sets that are grouped together (block 1210). For example, the network node (e.g., using reception component 1402, depicted in FIG. 14) may receive, from a UE, a first CSI report, wherein the first CSI report indicates L1-RSRP/SINR measurements and associated CMR IDs based at least in part on multiple CMR sets that are grouped together, as described above.

As further shown in FIG. 12, in some aspects, process 1200 may include receiving, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report (block 1220). For example, the network node (e.g., using reception component 1402, depicted in FIG. 14) may receive, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report, as described above.

Process 1200 may include additional aspects, such as any single aspect or any combination of aspects described below and/or in connection with one or more other processes described elsewhere herein.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of a selection component 1308, or a performance component 1310, among other examples.

In some aspects, the apparatus 1300 may be configured to perform one or more operations described herein in connection with FIG. 10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The transmission component 1304 may transmit, to a network node, a first CSI report, wherein the first CSI report indicates L1-RSRP/SINR measurements and associated CMR IDs based at least in part on multiple CMR sets that are grouped together. The transmission component 1304 may transmit, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

The selection component 1308 may select the quantity of CMRs from one of the multiple CMR sets. The selection component 1308 may select the quantity of CMRs from multiple CMR subsets of the multiple CMR sets. The selection component 1308 may select the quantity of CMRs from identified CMR sets of the multiple CMR sets based at least in part on aperiodic CSI triggering state configuration, wherein the aperiodic CSI triggering state configuration indicates: a first CSI report setting ID associated with the first CSI report, and one or more CMR set IDs, of CMR set IDs associated with the multiple CMR sets, associated with the first CSI report setting, and wherein the quantity of CMRs are selected from the identified CMR sets associated with the one or more CMR set IDs based at least in part on a triggering of the second CSI report.

The selection component 1308 may select the quantity of CMRs from one or more of the multiple CMR sets based at least in part on an explicit indication using dedicated fields in an uplink grant DCI triggering the second CSI report, wherein the dedicated fields include one or more CMR set IDs, of CMR set IDs associated with the multiple CMR sets, associated with a first CSI report setting, wherein the quantity of CMRs are selected from one or more CMR sets associated with the one or more CMR set IDs based at least in part on a triggering of the second CSI report; and a first CSI report setting ID associated with the first CSI report.

The selection component 1308 may select the quantity of CMRs from one or more of the multiple CMR sets based at least in part on an implicit identification from a Type-D source reference signal of a CORESET carrying an uplink grant DCI triggering the second CSI report, wherein the uplink grant DCI is received using the Type-D source reference signal of the CORESET that is quasi co-located with one or more CMRs from a first CMR set of the multiple CMR sets, and wherein the quantity of CMRs are selected from CMR sets other than the first CMR set of the multiple CMR sets, or wherein the quantity of CMRs are selected from the first CMR set.

The selection component 1308 may select the quantity of CMRs from all of the multiple CMR sets. The selection component 1308 may select the quantity of CMRs based at least in part on remaining strongest CMRs within identified CMR sets.

The selection component 1308 may select the quantity of CMRs based at least in part on remaining weakest CMRs within the identified CMR sets. The selection component 1308 may select the quantity of CMRs based at least in part on remaining CMRs within a certain RSRP/SINR range. The selection component 1308 may select the quantity of CMRs based at least in part on all remaining CMRs. The selection component 1308 may select the quantity of CMRs based at least in part on an explicit indication, received from the network node, that triggers the second CSI report. The selection component 1308 may select the quantity of CMRs based at least in part on a standard predefinition or a configuration received from the network node, wherein the configuration indicates a value associated with the quantity of CMRs.

The performance component 1310 may perform a quantization of the additional L1-RSRP/SINR measurements associated with the quantity of CMRs included in the second CSI report, wherein the additional L1-RSRP/SINR measurements are quantized differentially referring to a strongest or weakest L1-RSRP/SINR measurement in the first CSI report; the additional L1-RSRP/SINR measurements are quantized differentially referring to a strongest or weakest L1-RSRP/SINR measurement within selected CMR sets within the first CSI report; a strongest additional L1-RSRP/SINR measurement, carried in the second CSI report, is quantized absolutely, and remaining additional L1-RSRP/SINR measurements of the second CSI report are quantized differentially referring to the strongest additional L1-RSRP/SINR measurement carried in the second CSI report; or a first portion of additional L1-RSRP/SINR measurements are quantized using a first mechanism and a second portion of additional L1-RSRP/SINR measurements are quantized using a second mechanism that is different from the first mechanism.

The reception component 1302 may receive, from the network node, a CSI associated report configuration that indicates one or more of one or more CMR set IDs, of CMR set IDs associated with the multiple CMR sets, associated with a first CSI report setting, wherein the one or more CMR set IDs indicate the quantity of CMRs to be addressed in the second CSI report; a CSI report setting ID associated with the first CSI report, wherein the CSI report setting ID indicates the first CSI report that is to be associated with the second CSI report; a determination scheme for determining the quantity of CMRs; or a quantization scheme for quantizing the additional L1-RSRP/SINR measurements associated with the quantity of CMRs.

The reception component 1302 may receive, from the network node, a CSI associated report configuration that indicates a CSI report setting ID associated with the first CSI report, wherein the CSI report setting ID indicates the first CSI report that is to be associated with the second CSI report. The reception component 1302 may receive, from the network node, dedicated fields within an uplink grant DCI, wherein the dedicated fields indicate one or more of one or more CMR set IDs, of CMR set IDs associated with the multiple CMR sets, associated with a first CSI report setting, wherein the one or more CMR set IDs indicate the quantity of CMRs to be addressed in the second CSI report; a determination scheme for determining the quantity of CMRs; or a quantization scheme for quantizing the additional L1-RSRP/SINR measurements associated with the quantity of CMRs.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404.

In some aspects, the apparatus 1400 may be configured to perform one or more operations described herein in connection with FIG. 10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The reception component 1402 may receive, from a UE, a first CSI report, wherein the first CSI report indicates L1-RSRP/SINR measurements and associated CMR IDs based at least in part on multiple CMR sets that are grouped together. The reception component 1402 may receive, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: transmitting, to a network node, a first channel state information (CSI) report, wherein the first CSI report indicates layer 1 (L1) reference signal received power (RSRP) or signal-to-interference-plus-noise ratio (SINR) (L1-RSRP/SINR) measurements and associated channel measurement resource (CMR) identifiers (IDs) based at least in part on multiple CMR sets that are grouped together; and transmitting, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

Aspect 2: The method of Aspect 1, wherein the first CSI report is a periodic CSI report, a semi-persistent CSI report, or an aperiodic CSI report, and wherein the second CSI report is an aperiodic CSI report that is dynamically triggered by the network node.

Aspect 3: The method of any of Aspects 1 through 2, further comprising: selecting the quantity of CMRs from one of the multiple CMR sets; or selecting the quantity of CMRs from multiple CMR subsets of the multiple CMR sets.

Aspect 4: The method of any of Aspects 1 through 3, further comprising: selecting the quantity of CMRs from identified CMR sets of the multiple CMR sets based at least in part on aperiodic CSI triggering state configuration, wherein the aperiodic CSI triggering state configuration indicates: a first CSI report setting ID associated with the first CSI report, and one or more CMR set IDs, of CMR set IDs associated with the multiple CMR sets, associated with the first CSI report setting, and wherein the quantity of CMRs are selected from the identified CMR sets associated with the one or more CMR set IDs based at least in part on a triggering of the second CSI report.

Aspect 5: The method of any of Aspects 1 through 4, further comprising: selecting the quantity of CMRs from one or more of the multiple CMR sets based at least in part on an explicit indication using dedicated fields in an uplink grant downlink control information (DCI) triggering the second CSI report, wherein the dedicated fields include: one or more CMR set IDs, of CMR set IDs associated with the multiple CMR sets, associated with a first CSI report setting, wherein the quantity of CMRs are selected from one or more CMR sets associated with the one or more CMR set IDs based at least in part on a triggering of the second CSI report; and a first CSI report setting ID associated with the first CSI report.

Aspect 6: The method of any of Aspects 1 through 5, further comprising: selecting the quantity of CMRs from one or more of the multiple CMR sets based at least in part on an implicit identification from a Type-D source reference signal of a control resource set (CORESET) carrying an uplink grant downlink control information (DCI) triggering the second CSI report, wherein the uplink grant DCI is received using the Type-D source reference signal of the CORESET that is quasi co-located with one or more CMRs from a first CMR set of the multiple CMR sets, and wherein the quantity of CMRs are selected from CMR sets other than the first CMR set of the multiple CMR sets, or wherein the quantity of CMRs are selected from the first CMR set.

Aspect 7: The method of any of Aspects 1 through 6, further comprising: selecting the quantity of CMRs from all of the multiple CMR sets.

Aspect 8: The method of any of Aspects 1 through 7, further comprising: selecting the quantity of CMRs based at least in part on remaining strongest CMRs within identified CMR sets; selecting the quantity of CMRs based at least in part on remaining weakest CMRs within the identified CMR sets; selecting the quantity of CMRs based at least in part on remaining CMRs within a certain RSRP/SINR range; selecting the quantity of CMRs based at least in part on all remaining CMRs; or selecting the quantity of CMRs based at least in part on an explicit indication, received from the network node, that triggers the second CSI report.

Aspect 9: The method of any of Aspects 1 through 8, further comprising: selecting the quantity of CMRs based at least in part on a standard predefinition or a configuration received from the network node, wherein the configuration indicates a value associated with the quantity of CMRs.

Aspect 10: The method of any of Aspects 1 through 9, further comprising: performing a quantization of the additional L1-RSRP/SINR measurements associated with the quantity of CMRs included in the second CSI report, wherein: the additional L1-RSRP/SINR measurements are quantized differentially referring to a strongest or weakest L1-RSRP/SINR measurement in the first CSI report; the additional L1-RSRP/SINR measurements are quantized differentially referring to a strongest or weakest L1-RSRP/SINR measurement within selected CMR sets within the first CSI report; a strongest additional L1-RSRP/SINR measurement, carried in the second CSI report, is quantized absolutely, and remaining additional L1-RSRP/SINR measurements of the second CSI report are quantized differentially referring to the strongest additional L1-RSRP/SINR measurement carried in the second CSI report; or a first portion of additional L1-RSRP/SINR measurements are quantized using a first mechanism and a second portion of additional L1-RSRP/SINR measurements are quantized using a second mechanism that is different from the first mechanism.

Aspect 11: The method of any of Aspects 1 through 10, further comprising: receiving, from the network node, a CSI associated report configuration that indicates one or more of: one or more CMR set IDs, of CMR set IDs associated with the multiple CMR sets, associated with a first CSI report setting, wherein the one or more CMR set IDs indicate the quantity of CMRs to be addressed in the second CSI report; a CSI report setting ID associated with the first CSI report, wherein the CSI report setting ID indicates the first CSI report that is to be associated with the second CSI report; a determination scheme for determining the quantity of CMRs; or a quantization scheme for quantizing the additional L1-RSRP/SINR measurements associated with the quantity of CMRs.

Aspect 12: The method of any of Aspects 1 through 11, further comprising: receiving, from the network node, a CSI associated report configuration that indicates a CSI report setting ID associated with the first CSI report, wherein the CSI report setting ID indicates the first CSI report that is to be associated with the second CSI report; and receiving, from the network node, dedicated fields within an uplink grant downlink control information (DCI), wherein the dedicated fields indicate one or more of: one or more CMR set IDs, of CMR set IDs associated with the multiple CMR sets, associated with a first CSI report setting, wherein the one or more CMR set IDs indicate the quantity of CMRs to be addressed in the second CSI report; a determination scheme for determining the quantity of CMRs; or a quantization scheme for quantizing the additional L1-RSRP/SINR measurements associated with the quantity of CMRs.

Aspect 13: The method of any of Aspects 1 through 12, wherein the network node is associated with a first transmission reception point (TRP) and a second TRP, and wherein the second CSI report is triggered to indicate the additional L1-RSRP/SINR measurements for the quantity of CMRs associated with the second TRP, based at least in part on a predicted beam quality for the first TRP satisfying a threshold and a predicted beam quality for the second TRP not satisfying the threshold.

Aspect 14: The method of any of Aspects 1 through 13, wherein the second CSI report that indicates the additional L1-RSRP/SINR measurements is for a predictive beam management for multiple transmission reception points.

Aspect 15: A method of wireless communication performed by a network node, comprising: receiving, from a user equipment (UE), a first channel state information (CSI) report, wherein the first CSI report indicates layer 1 (L1) reference signal received power (RSRP) or signal-to-interference-plus-noise ratio (SINR) (L1-RSRP/SINR) measurements and associated channel measurement resource (CMR) identifiers (IDs) based at least in part on multiple CMR sets that are grouped together; and receiving, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspects 15.

Aspect 22: A device for wireless communication, comprising a memory and one or more processors coupled to the memory, the one or more processors configured to perform the method of Aspects 15.

Aspect 23: An apparatus for wireless communication, comprising at least one means for perform the method of Aspects 15.

Aspect 24: A non-transitory computer-readable medium storing code for wireless communication, the code comprising instructions executable by a processor to perform the method of Aspects 15.

Aspect 25: A non-transitory computer-readable medium storing a set of instructions for wireless communication, the set of instructions comprising one or more instructions that, when executed by one or more processors of a device, cause the device to perform the method of Aspects 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit, to a network node, a first channel state information (CSI) report, wherein the first CSI report indicates layer 1 (L1) reference signal received power (RSRP) or signal-to-interference-plus-noise ratio (SINR) (L1-RSRP/SINR) measurements and associated channel measurement resource (CMR) identifiers (IDs) based at least in part on multiple CMR sets that are grouped together; and
transmit, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

2. The apparatus of claim 1, wherein the first CSI report is a periodic CSI report, a semi-persistent CSI report, or an aperiodic CSI report, and wherein the second CSI report is an aperiodic CSI report that is dynamically triggered by the network node.

3. The apparatus of claim 1, wherein the one or more processors are further configured to:
select the quantity of CMRs from one of the multiple CMR sets; or
select the quantity of CMRs from multiple CMR subsets of the multiple CMR sets.

4. The apparatus of claim 1, wherein the one or more processors are further configured to:
select the quantity of CMRs from identified CMR sets of the multiple CMR sets based at least in part on aperiodic CSI triggering state configuration, wherein the aperiodic CSI triggering state configuration indicates: a first CSI report setting ID associated with the first CSI report, and one or more CMR set IDs, of CMR set IDs associated with the multiple CMR sets, associated with the first CSI report setting, and wherein the quantity of CMRs are selected from the identified CMR sets associated with the one or more CMR set IDs based at least in part on a triggering of the second CSI report.

5. The apparatus of claim 1, wherein the one or more processors are further configured to:
select the quantity of CMRs from one or more of the multiple CMR sets based at least in part on an explicit indication using dedicated fields in an uplink grant downlink control information (DCI) triggering the second CSI report, wherein the dedicated fields include:
one or more CMR set IDs, of CMR set IDs associated with the multiple CMR sets, associated with a first CSI report setting, wherein the quantity of CMRs are selected from one or more CMR sets associated with the one or more CMR set IDs based at least in part on a triggering of the second CSI report; and
a first CSI report setting ID associated with the first CSI report.

6. The apparatus of claim 1, wherein the one or more processors are further configured to:
select the quantity of CMRs from one or more of the multiple CMR sets based at least in part on an implicit identification from a Type-D source reference signal of a control resource set (CORESET) carrying an uplink grant downlink control information (DCI) triggering the second CSI report, wherein the uplink grant DCI is received using the Type-D source reference signal of the CORESET that is quasi co-located with one or more CMRs from a first CMR set of the multiple CMR sets, and wherein the quantity of CMRs are selected from CMR sets other than the first CMR set of the multiple CMR sets, or wherein the quantity of CMRs are selected from the first CMR set.

7. The apparatus of claim 1, wherein the one or more processors are further configured to:
select the quantity of CMRs from all of the multiple CMR sets.

8. The apparatus of claim 1, wherein the one or more processors are further configured to:
select the quantity of CMRs based at least in part on remaining strongest CMRs within identified CMR sets;
select the quantity of CMRs based at least in part on remaining weakest CMRs within the identified CMR sets;
select the quantity of CMRs based at least in part on remaining CMRs within a certain RSRP/SINR range;
select the quantity of CMRs based at least in part on all remaining CMRs; or
select the quantity of CMRs based at least in part on an explicit indication, received from the network node, that triggers the second CSI report.

9. The apparatus of claim 1, wherein the one or more processors are further configured to:
select the quantity of CMRs based at least in part on a standard predefinition or a configuration received from the network node, wherein the configuration indicates a value associated with the quantity of CMRs.

10. The apparatus of claim 1, wherein the one or more processors are further configured to:
perform a quantization of the additional L1-RSRP/SINR measurements associated with the quantity of CMRs included in the second CSI report, wherein:
the additional L1-RSRP/SINR measurements are quantized differentially referring to a strongest or weakest L1-RSRP/SINR measurement in the first CSI report;
the additional L1-RSRP/SINR measurements are quantized differentially referring to a strongest or weakest L1-RSRP/SINR measurement within selected CMR sets within the first CSI report;
a strongest additional L1-RSRP/SINR measurement, carried in the second CSI report, is quantized absolutely, and remaining additional L1-RSRP/SINR measurements of the second CSI report are quantized differentially referring to the strongest additional L1-RSRP/SINR measurement carried in the second CSI report; or
a first portion of additional L1-RSRP/SINR measurements are quantized using a first mechanism and a second portion of additional L1-RSRP/SINR measurements are quantized using a second mechanism that is different from the first mechanism.

11. The apparatus of claim 1, wherein the one or more processors are further configured to:
receive, from the network node, a CSI associated report configuration that indicates one or more of:
one or more CMR set IDs, of CMR set IDs associated with the multiple CMR sets, associated with a first CSI report setting, wherein the one or more CMR set IDs indicate the quantity of CMRs to be addressed in the second CSI report;
a CSI report setting ID associated with the first CSI report, wherein the CSI report setting ID indicates the first CSI report that is to be associated with the second CSI report;
a determination scheme for determining the quantity of CMRs; or
a quantization scheme for quantizing the additional L1-RSRP/SINR measurements associated with the quantity of CMRs.

12. The apparatus of claim 1, wherein the one or more processors are further configured to:
receive, from the network node, a CSI associated report configuration that indicates a CSI report setting ID associated with the first CSI report, wherein the CSI report setting ID indicates the first CSI report that is to be associated with the second CSI report; and
receive, from the network node, dedicated fields within an uplink grant downlink control information (DCI), wherein the dedicated fields indicate one or more of:
one or more CMR set IDs, of CMR set IDs associated with the multiple CMR sets, associated with a first CSI report setting, wherein the one or more CMR set IDs indicate the quantity of CMRs to be addressed in the second CSI report;
a determination scheme for determining the quantity of CMRs; or
a quantization scheme for quantizing the additional L1-RSRP/SINR measurements associated with the quantity of CMRs.

13. The apparatus of claim 1, wherein the network node is associated with a first transmission reception point (TRP) and a second TRP, and wherein the second CSI report is triggered to indicate the additional L1-RSRP/SINR measurements for the quantity of CMRs associated with the second TRP, based at least in part on a predicted beam quality for the first TRP satisfying a threshold and a predicted beam quality for the second TRP not satisfying the threshold.

14. The apparatus of claim 1, wherein the second CSI report that indicates the additional L1-RSRP/SINR measurements is for a predictive beam management for multiple transmission reception points.

15. An apparatus for wireless communication at a network node, comprising:
a memory; and
one or more processors, coupled to the memory, configured to:
receive, from a user equipment (UE), a first channel state information (CSI) report, wherein the first CSI report indicates layer 1 (L1) reference signal received power (RSRP) or signal-to-interference-plus-noise ratio (SINR) (L1-RSRP/SINR) measurements and associated channel measurement resource (CMR) identifiers (IDs) based at least in part on multiple CMR sets that are grouped together; and
receive, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

16. A method of wireless communication performed by a user equipment (UE), comprising:
transmitting, to a network node, a first channel state information (CSI) report, wherein the first CSI report indicates layer 1 (L1) reference signal received power (RSRP) or signal-to-interference-plus-noise ratio (SINR) (L1-RSRP/SINR) measurements and associated channel measurement resource (CMR) identifiers (IDs) based at least in part on multiple CMR sets that are grouped together; and
transmitting, to the network node, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.

17. The method of claim 16, wherein the first CSI report is a periodic CSI report, a semi-persistent CSI report, or an aperiodic CSI report, and wherein the second CSI report is an aperiodic CSI report that is dynamically triggered by the network node.

18. The method of claim 16, further comprising:
selecting the quantity of CMRs from one of the multiple CMR sets; or
selecting the quantity of CMRs from multiple CMR subsets of the multiple CMR sets.

19. The method of claim 16, further comprising:
selecting the quantity of CMRs from identified CMR sets of the multiple CMR sets based at least in part on aperiodic CSI triggering state configuration, wherein the aperiodic CSI triggering state configuration indicates: a first CSI report setting ID associated with the first CSI report, and one or more CMR set IDs, of CMR set IDs associated with the multiple CMR sets, associated with the first CSI report setting, and wherein the quantity of CMRs are selected from the identified CMR sets associated with the one or more CMR set IDs based at least in part on a triggering of the second CSI report.

20. The method of claim 16, further comprising:
selecting the quantity of CMRs from one or more of the multiple CMR sets based at least in part on an explicit indication using dedicated fields in an uplink grant downlink control information (DCI) triggering the second CSI report, wherein the dedicated fields include:
one or more CMR set IDs, of CMR set IDs associated with the multiple CMR sets, associated with a first CSI report setting, wherein the quantity of CMRs are selected from one or more CMR sets associated with the one or more CMR set IDs based at least in part on a triggering of the second CSI report; and
a first CSI report setting ID associated with the first CSI report.

21. The method of claim 16, further comprising:
selecting the quantity of CMRs from one or more of the multiple CMR sets based at least in part on an implicit identification from a Type-D source reference signal of a control resource set (CORESET) carrying an uplink grant downlink control information (DCI) triggering the second CSI report, wherein the uplink grant DCI is received using the Type-D source reference signal of the CORESET that is quasi co-located with one or more CMRs from a first CMR set of the multiple CMR sets, and wherein the quantity of CMRs are selected from CMR sets other than the first CMR set of the multiple CMR sets, or wherein the quantity of CMRs are selected from the first CMR set.

22. The method of claim 16, further comprising:
selecting the quantity of CMRs from all of the multiple CMR sets.

23. The method of claim 16, further comprising:
selecting the quantity of CMRs based at least in part on remaining strongest CMRs within identified CMR sets;
selecting the quantity of CMRs based at least in part on remaining weakest CMRs within the identified CMR sets;
selecting the quantity of CMRs based at least in part on remaining CMRs within a certain RSRP/SINR range;
selecting the quantity of CMRs based at least in part on all remaining CMRs; or
selecting the quantity of CMRs based at least in part on an explicit indication, received from the network node, that triggers the second CSI report.

24. The method of claim 16, further comprising:
selecting the quantity of CMRs based at least in part on a standard predefinition or a configuration received from the network node, wherein the configuration indicates a value associated with the quantity of CMRs.

25. The method of claim 16, further comprising:
performing a quantization of the additional L1-RSRP/SINR measurements associated with the quantity of CMRs included in the second CSI report, wherein:
the additional L1-RSRP/SINR measurements are quantized differentially referring to a strongest or weakest L1-RSRP/SINR measurement in the first CSI report;
the additional L1-RSRP/SINR measurements are quantized differentially referring to a strongest or weakest L1-RSRP/SINR measurement within selected CMR sets within the first CSI report;
a strongest additional L1-RSRP/SINR measurement, carried in the second CSI report, is quantized absolutely, and remaining additional L1-RSRP/SINR measurements of the second CSI report are quantized differentially referring to the strongest additional L1-RSRP/SINR measurement carried in the second CSI report; or
a first portion of additional L1-RSRP/SINR measurements are quantized using a first mechanism and a second portion of additional L1-RSRP/SINR measurements are quantized using a second mechanism that is different from the first mechanism.

26. The method of claim 16, further comprising:
receiving, from the network node, a CSI associated report configuration that indicates one or more of:
one or more CMR set IDs, of CMR set IDs associated with the multiple CMR sets, associated with a first CSI report setting, wherein the one or more CMR set IDs indicate the quantity of CMRs to be addressed in the second CSI report;
a CSI report setting ID associated with the first CSI report, wherein the CSI report setting ID indicates the first CSI report that is to be associated with the second CSI report;
a determination scheme for determining the quantity of CMRs; or
a quantization scheme for quantizing the additional L1-RSRP/SINR measurements associated with the quantity of CMRs.

27. The method of claim 16, further comprising:
receiving, from the network node, a CSI associated report configuration that indicates a CSI report setting ID associated with the first CSI report, wherein the CSI report setting ID indicates the first CSI report that is to be associated with the second CSI report; and
receiving, from the network node, dedicated fields within an uplink grant downlink control information (DCI), wherein the dedicated fields indicate one or more of:
one or more CMR set IDs, of CMR set IDs associated with the multiple CMR sets, associated with a first CSI report setting, wherein the one or more CMR set IDs indicate the quantity of CMRs to be addressed in the second CSI report;
a determination scheme for determining the quantity of CMRs; or
a quantization scheme for quantizing the additional L1-RSRP/SINR measurements associated with the quantity of CMRs.

28. The method of claim 16, wherein the network node is associated with a first transmission reception point (TRP) and a second TRP, and wherein the second CSI report is triggered to indicate the additional L1-RSRP/SINR measurements for the quantity of CMRs associated with the second TRP, based at least in part on a predicted beam quality for the first TRP satisfying a threshold and a predicted beam quality for the second TRP not satisfying the threshold.

29. The method of claim 16, wherein the second CSI report that indicates the additional L1-RSRP/SINR measurements is for a predictive beam management for multiple transmission reception points.

30. A method of wireless communication performed by a network node, comprising:
receiving, from a user equipment (UE), a first channel state information (CSI) report, wherein the first CSI report indicates layer 1 (L1) reference signal received power (RSRP) or signal-to-interference-plus-noise ratio (SINR) (L1-RSRP/SINR) measurements and associated channel measurement resource (CMR) identifiers (IDs) based at least in part on multiple CMR sets that are grouped together; and
receiving, from the UE, a second CSI report that indicates additional L1-RSRP/SINR measurements not reported in the first CSI report, wherein the additional L1-RSRP/SINR measurements are associated with a quantity of CMRs, of the multiple CMR sets, having CMR IDs that are different from the CMR IDs associated with the first CSI report.
